(19) United States
(12) Patent Application Publication
(10) Pub. No.: US 2003/0182550 A1
(43) Pub. Date: Sep. 25, 2003

(54) System and method for dynamic activation of enterprise Java beans

(76) Inventors: Michael Chen, Santa Clara, CA (US); Prasad Peddada, Davis, CA (US); Anno R. Langen, San Jose, CA (US)

Correspondence Address: Sheldon R. Meyer, FLIESLER DUBB MEYER & LOVEJOY LLP, Four Embarcadero Center, Fourth Floor, San Francisco, CA, 94111-4156, US

(21) Appl. No.: 10/370,930

(22) Filed: Feb. 20, 2003

Related U.S. Application Data
(60) Provisional application No. 60/358,751, filed on Feb. 21, 2002.

(51) Int. Cl. H04L 9/00

(52) U.S. Cl. 713/167

(57) ABSTRACT

A system and a method for dynamic or as-needed activation of EJB's in response to a client request. Particularly, EJB object activation allows the system to clean up currently unused objects, and to recreate them on demand when a client needs them. EJB activation thus provides support for remote server objects that require persistent access overtime and that can be activated by the system. In accordance with one embodiment the object activation system activates a remote server EJB for a client based on an ActivationID previously received from the server. This relieves the container from keeping track of remote object interfaces, and allows the system to be more scalable.

### CLAIM OF PRIORITY

This application claims priority from provisional application “SYSTEM AND METHOD FOR DYNAMIC ACTIVATION OF ENTERPRISE JAVA BEANS” Application No. 60/358,751 filed Feb. 21, 2002, and which application is incorporated herein by reference.

### FIELD OF THE INVENTION

The invention relates generally to a system and method for dynamic EJB activation in a Java server environment.

### CROSS-REFERENCES

This application is related to co-pending application U.S. Provisional Patent Application SYSTEM AND METHOD FOR OBJECT ACTIVATION; Inventors: Prasad Peddada and Anno Langen Application No. 60/358,767, filed Feb. 21, 2002, which application is incorporated herein by reference.

### BACKGROUND

An ever-increasing number of e-commerce providers or e-businesses rely on application server technology as the lifeblood of their business. Application servers form a proven foundation for developing and supporting e-commerce applications, providing the presentation, business and information-access logic, security and management services, and the underlying infrastructure required for running highly scalable and mission-critical software applications. Increasingly, the demands of today's modern businesses require support for a new breed of Web and wireless applications, helping to meet the needs of increasingly sophisticated customers.

One such application server, WebLogic Server, from BEA Systems, Inc. San Jose, Calif., is based on an implementation of the Java 2 Enterprise Edition (J2EE) specification. WebLogic Server is used as the backbone for many of today's most sophisticated e-business applications, and plays an integral role in a tightly integrated, comprehensive infrastructure that delivers commerce, personalization, campaign management, enterprise integration, workflow management, and business-to-business collaboration. WebLogic Server manages all of the underlying complexities of a business' e-commerce applications, allows the organization to focus instead on delivering new and innovative products and services.

A typical application server, including WebLogic Server, supports a variety of clients, including Web browsers, and wireless devices. On the server side, WebLogic Server supports a variety of operating systems. On the back-end, WebLogic Server integrates with relational databases, messages queues, and legacy systems. WebLogic Server also provides support for features such as Servlets, Java Server Pages (JSPs), Enterprise JavaBeans (EJBs), and Java Messaging Service (JMS), to provide access to standard network protocols, database, and messaging systems. When developing applications, developers can create, assemble, and deploy components that use these services. To allow communication between each of these entities, application servers typically allow applications to pass messages to each other. Messages are events that contain information needed to coordinate communication between different applications. A message thus provides a level of abstraction, allowing the software developer to separate out the details about the destination system from the application, and concentrate on developing the application code itself.

The EJB architecture used by such application servers encourages portability and reuse of application code. In accordance with the industry-standard EJB specification, enterprise bean instances are created and managed at application run time by an EJB container. An EJB container is an entity that provides lifecycle management, security deployment and run time services to EJB components. The EJB container may also provide component-specific or EJB-specific services. When an enterprise bean uses only those standard services defined in the EJB specification, the bean can be deployed within any compliant EJB container. However, some specialized containers can be used to provide additional services beyond those defined by the specification.

Besides its actual implementation, the behavior of the EJB can also be defined during deployment. EJB's are deployed using a deployment descriptor, typically a computer-readable file or group of files that specifies deployment assembly information and settings. By modifying the entries within this deployment descriptor the behavior of the EJB can be customized. This flexibility makes it easy to include an EJB within an application at a later point in time without having to make any changes to the application source code.

A problem with application servers as they are currently implemented, is that the EJB container must keep track of all of the remote object interfaces (eolmpl) as they are created. As the server handles request from clients, additional object implementations are created. Because the server does not know when (if ever) these implementations will be reused by the client, it typically does not remove them during a garbage collection process. As such, the number of object implementations steadily increases during use. This increase in objects limits the scalability of the EJB container and can be the cause of memory leaks for stateful session and entity beans. Mechanisms that can increase scalability are highly desirable in allowing a company to respond quickly and flexibly to the demands of today's rapidly growing e-commerce industry.

### SUMMARY

The invention provides a system and a method for dynamic or as-needed activation of EJB's in response to a client request. Particularly, EJB object activation allows the system to clean up currently unused objects, and to recreate them on demand when a client needs them. EJB activation thus provides support for remote server objects that require persistent access over time and that can be activated by the system. In accordance with one embodiment the object activation system activates a remote server EJB for a client based on an ActivationID previously received from the server. This relieves the container from keeping track of remote object interfaces, and allows the system to be more scalable.

### BRIEF DESCRIPTION OF THE DRAWINGS

FIGS. 1A through 1C illustrates a schematic of an application server in which EJB object activation is not used.

FIGS. 2A through 2C illustrates a schematic of an application server that uses EJB object activation in accordance with the invention.

FIG. 3 shows a flowchart of a method used by a server to activate objects in response to a client request.

FIG. 4 shows a flowchart of a method used by a client to access server-based objects using object activation.

### DETAILED DESCRIPTION

The invention provides a system and a method for dynamic or as-needed activation of EJB's in response to a client request. Particularly, EJB object activation allows the system to clean up currently unused objects, and to recreate them on demand when a client needs them. Object activation provides support for remote objects that require persistent access overtime and that can be activated by the system. A remote object can for example be activated on demand based on the ActivationID. Currently, the EJB container uses an RMI object, based on the RMI object implementation. The container needs to keep track of all of the remote object interfaces (eolmpl). In one example. a SoftHashMap-eoMap is maintained as a lookup between pk (Primary Key) and eo (EJB object-eolmpl) for the current RMI implementation. This approach limits the scalability of the container and causes some memory leak issues for both stateful session and entity beans. Since every entity bean represents an entry in the database, users can not invoke remove( ) method on the entity bean if they do not want to remove the entry; therefore the Primary Key and EJB object cannot be removed from the eoMap. A unwanted side effect of this approach is that the number of Primary Keys and EJB objects, and the size of the eoMap increases as more beans is created.

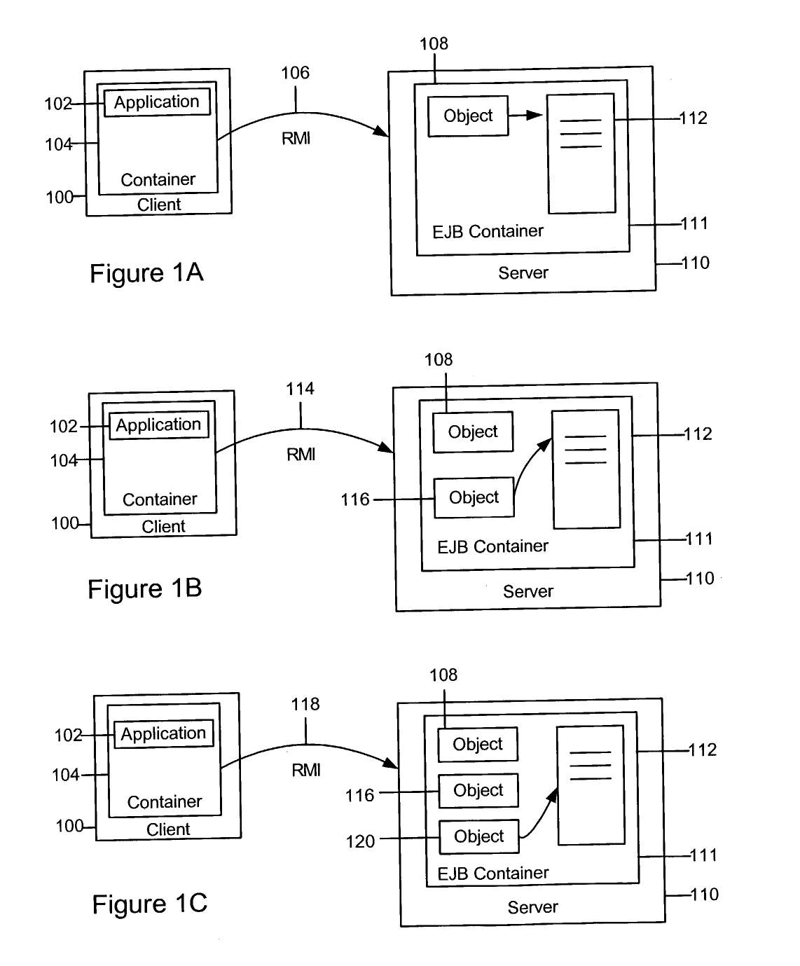

FIGS. 1A through 1C illustrates a schematic of an application server in which EJB object activation is not used. As shown in FIG. 1A, a client 100, including a client application 102 within an application container 104, uses RMI 106 to contact a remote server 110. In response to this RMI request, the server will create an object instance, for example an EJB bean instance 108. The server's EJB container 111 must keep track of each of these remote object instances, typically through the use of a hash table or some other form of lookup table 112. As each new object is activated, this lookup table is updated to reflect the additional instances. FIG. 1B illustrates a subsequent step in the process in which a new client, or perhaps the same client, makes an additional RMI request through the remote server. In response to this request the remote server creates a new object implementation, and the reference for this object implementation is added to the look up table 112. FIG. 1C illustrates the sequence in which additional RMI requests are placed, causing each request to generate a new object on the server within the EJB container, and adding this object to the lookup table. As can be seen from FIG. 1C, as RMI requests are handled from the client application, the remote EJB container must expand to include each additional object. This traditional method of servicing client requests places strain on the server both in terms of performance and scalability. Because each object represents a particular entry in the server's database the client application cannot invoke a remove method on that particular entity bean if they do not want to remove the entry from the database. As a result, the number of objects and the size of the lookup table gradually increases as more and more beans are added. In extreme circumstances the server may experience memory leak problems and diminished performance.

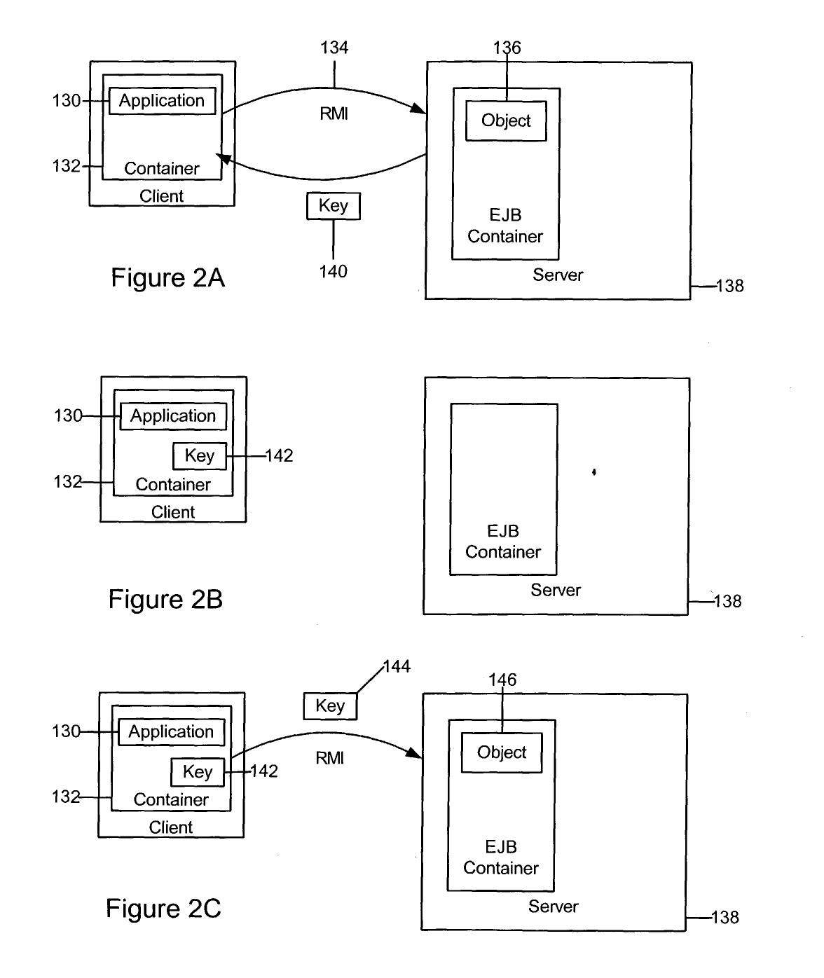

FIGS. 2A through 2C illustrates a schematic of an application server that uses EJB object activation in accordance with the invention. As can be seen in FIG. 2A, when a client, including a application container 132 and a client application 130, makes an RMI request 134 to a remote server 138, the system creates the object implementation, and generates a key for that particular object implementation 140. The key is passed back to the calling application. As shown in FIG. 2B the client then retains this key 142. Each key 142 is unique to the particular implementation with which it was created. As such, as shown in FIG. 2B the EJB container may subsequently remove the object during a garbage collection phase, which minimizes scalability problems associated with having an increasing number of objects active on the server. In FIG. 2C, when the client application later wishes to uses that same object implementation, it passes the key 142 along with the RMI request 144 to the remote server. The remote server then uses this key to reactivate the object 146 in the EJB container. Object 136 and Object 146 may or may not be the same object depending on whether a garbage collection deletes Object 136 between the two remote client RMI calls or not. If garbage collection did not delete Object 136 between the two remote client RMI calls, Object 136 and Object 146 will be the same object; otherwise, they are a different objects, but with identical internal states.

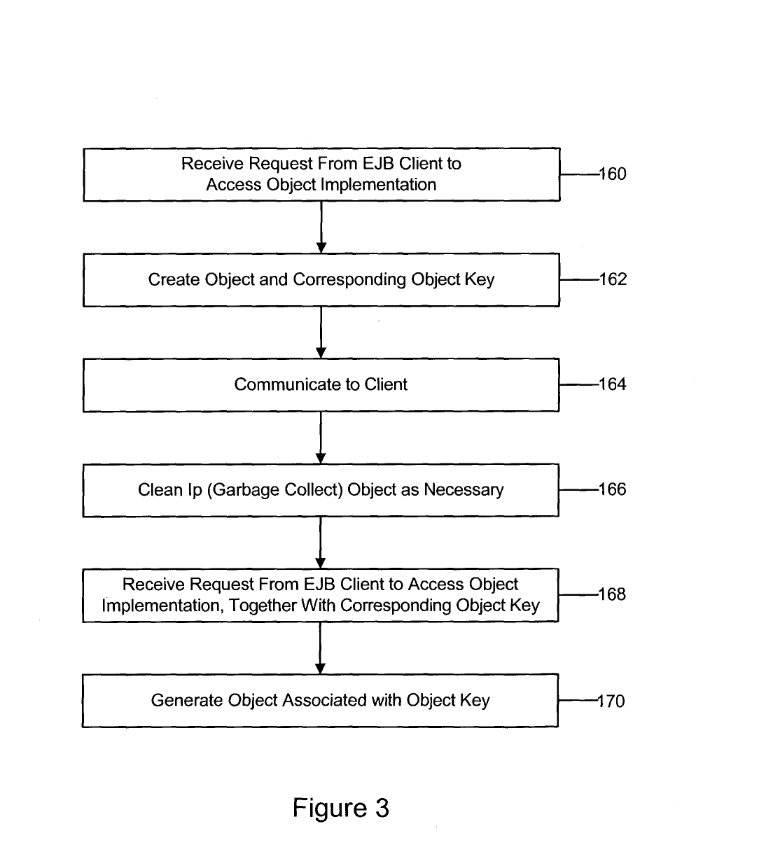

FIG. 3 shows a flowchart of a method used by the server to activate objects in response to a client request. As shown in FIG. 3, a first step in the process, step 160, is to receive a request from an EJB client to access an object implementation. The server creates the corresponding object and generates a key corresponding to this object in step 162. In step 164, this key is communicated to the client, in response to the clients request. Once the client has this key, the server may at any later point, in step 166, garbage collect or otherwise delete the object implementation. In step 168, when the server receives a request from the EJB client to access the same object implementation, it will also receive the corresponding object implementation key from that client. It uses this key, in step 170, to reactivate or generate the object associated with the object key.

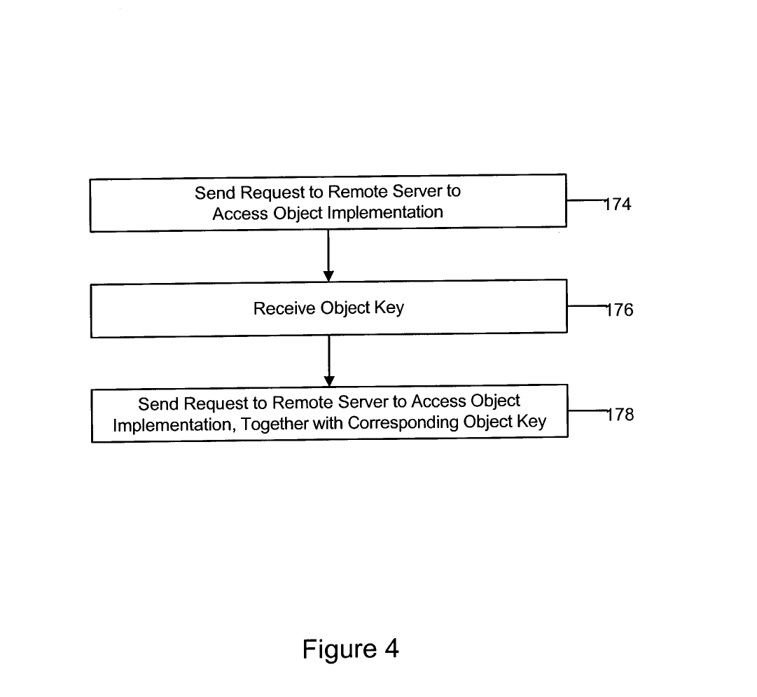

FIG. 4 shows a flowchart of a method used by a client to access server-based objects using object activation. As shown in FIG. 4, from the client's perspective, in step 174, the client sends a request as usual to the remote server to access a particular object implementation. As part of the response to this request, the client, in step 176, receives an object key that is unique to that particular object implementation. At any later point in time, in step 178 the client may send a request to the remote server to access the object implementation. To ensure that the client accesses the correct implementation the object key is automatically sent together with the request. Although the client does not know (or does not care) whether the object actually exists on the server at the time of the request, if it is not currently active then the server will take care of automatically activating the corresponding object implementation.

Implementation Example

A typical implementation that uses the invention is described in further detail below. It will be evident to one skilled in the art that some of the features described below are general to all object based systems, while others are specific to certain application servers. It will be further evident to one skilled in the art that the principles described below are generally applicable to other application server environments. In one embodiment, the invention utilizes an object activation framework that forms a component part of the application server. The object activation framework exposes some software interfaces for use in object activation, and requires that the EJB container implements these interfaces in order to use the object activation. In accordance with this embodiment, the EJB container needs to implement the following:

1. Provide a helper class which implements the weblogic.rmi.extensions. server.Activatable interface,

2. Register the helper class to weblogic.rmi.extensions.server. Activatable.ActivatableManager

3. Use the Primary Key (pk) as the ActivationID for the activation framework to active the bean instance (bean_impl).

Since the object activation provides a way to activate a bean instance based on its is Primary Key, there is no need to keep track of all EJB objects for every bean instance. The number of EJB objects will be reduced to one for every EJB home.

For stateful session beans, there can be multiple ejbCreate( ) methods, and we keep multiple Primary Key for different ejbCreate( ) methods, but same Primary Key sometimes need to be mapped to different bean instance.

The embodiment of object activation described above relies on the software developer or deployer implementing their Primary Key efficiently since the container is going to use Primary Key as its ActivationID. If they do not implement their Primary Key efficiently, there will be some performance impact. To avoid this problem, the EJB container may be designed to implement a HashMap between the Primary Key and ActivationID, but this requires the additional overhead of maintaining a HashMap. Developers can also use an automatic Primary Key generation feature to avoid any inefficient Primary Key implementation.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. Particularly, it will be evident that while the examples described herein illustrate how the invention may be used in a WebLogic environment, other application server environments may use and benefit from the invention. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for dynamic EJB activation in a Java server environment, comprising:
an EJB server for receiving a request from an EJB client to access an EJB object implementation on the server, said EJB server includes;
an object activator for creating a corresponding server object and generating an object key corresponding to that object implementation, and
an object key communicator for communicating the object key to the client; and,
wherein the EJB server upon subsequently receiving a request from the EJB client to access an object implementation, said request including the object key, reactivates the object associated with the object key.

2. The system of claim 1 wherein the object implementation can be removed and subsequently reactivated upon request from the client.

3. The system of claim 1 wherein the object implementation can be removed during a garbage collection process.

4. The system of claim 3 wherein if the object is deleted during the garbage collection process the corresponding activated object will be a different object from the deleted object but with identical internal states.

5. The system of claim 1 wherein the system includes an object activation framework including software interfaces for using or controlling the object activation process.

6. A method for dynamic EJB activation in a Java server environment, comprising the steps of:
receiving a request from an EJB client to access an EJB object implementation on a server;
creating a corresponding server object and generating an object key corresponding to this object implementation;
communicating the object key to the client in response to the clients request;
inactivating the object implementation as required;
subsequently receiving a request from the EJB client to access the object implementation, together with an object key; and,
reactivating the object associated with the object key.

7. The method of claim 6 wherein the object implementation can be removed and subsequently reactivated upon request from the client.

8. The method of claim 6 wherein the object implementation can be removed during a garbage collection process.

9. The method of claim 8 wherein if the object is deleted during the garbage collection process the corresponding activated object will be a different object from the deleted object but with identical internal states.

10. The method of claim 6 wherein the system includes an object activation framework including software interfaces for using or controlling the object activation process.
